(19) United States
(12) Patent Application Publication
(10) Pub. No.: US 2026/0054358 A1
(43) Pub. Date: Feb. 26, 2026

(54) ELECTRIC TOOL

(71) Applicant: PANASONIC HOLDINGS CORPORATION, Osaka (JP)

(72) Inventors: Kotaro MOMOEDA, Osaka (JP); Kohei KOSAKA, Mie (JP)

(21) Appl. No.: 19/103,449

(22) PCT Filed: Jul. 26, 2023
(86) PCT No.: PCT/JP2023/027459

§ 371 Date: Feb. 12, 2025

(30) Foreign Application Priority Data
Aug. 31, 2022 (JP) 2022-138767

(51) Int. Cl. B25B 21/00; B25B 23/147; B25F 5/00; B25F 5/02

(52) U.S. Cl. CPC B25B 21/00; B25B 23/147; B25F 5/001; B25F 5/02

(57) ABSTRACT

An electric tool includes a motor, an output shaft, a transmission mechanism, a first bearing and a second bearing, and a cover. The output shaft is to be coupled to a tip tool. The transmission mechanism is engaged with the output shaft to transmit torque generated by the motor to the output shaft. The first bearing and the second bearing support the output shaft rotatably. The cover houses the motor, the transmission mechanism, the first bearing, and the second bearing. The first bearing is interposed between the second bearing and the tip tool. The second bearing is arranged to be in contact with the transmission mechanism and the cover in a region where the transmission mechanism is engaged with the output shaft.

### TECHNICAL FIELD

The present disclosure generally relates to an electric tool, and more particularly relates to an electric tool including a motor.

### BACKGROUND ART

Patent Literature 1 discloses a portable electric tool. The portable electric tool includes: an electric motor serving as a drive source; a speed reducer mechanism for transmitting rotational power generated by the electric motor; a driving unit for transmitting the rotational power from the speed reducer mechanism to a tip tool; a barrel shell that houses a bearing for holding the driving unit rotatably; and a grip shell that houses a switch unit for controlling the supply of electric power to the electric motor.

In a portable electric tool (electric tool) such as the one disclosed in Patent Literature 1, application of a radial load from a work target for the electric tool to the tip tool and the driving unit could produce instability in operations being performed.

### CITATION LIST

### Patent Literature

Patent Literature 1: JP 2009-28840 A

### SUMMARY OF INVENTION

In view of the foregoing background, it is therefore an object of the present disclosure to provide an electric tool contributing to stabilizing the operations being performed.

An electric tool according to an aspect of the present disclosure includes a motor, an output shaft, a transmission mechanism, a first bearing and a second bearing, and a cover. The output shaft is to be coupled to a tip tool. The transmission mechanism is engaged with the output shaft to transmit torque generated by the motor to the output shaft. The first bearing and the second bearing are arranged to support the output shaft rotatably. The cover houses the motor, the transmission mechanism, the first bearing, and the second bearing. The first bearing is interposed between the second bearing and the tip tool. The second bearing is arranged to be in contact with the transmission mechanism and the cover in a region where the transmission mechanism is engaged with the output shaft.

### BRIEF DESCRIPTION OF DRAWINGS

FIG. 1 is a cross-sectional view of an electric tool according to an exemplary embodiment;

FIG. 2 is a perspective view illustrating the appearance of the electric tool;

FIG. 3 is a cross-sectional view of a main part of the electric tool;

FIG. 4 is a block diagram of the electric tool;

FIG. 5 is an exploded perspective view of a transmission mechanism included in the electric tool as viewed from in front of the transmission mechanism;

FIG. 6 is an exploded perspective view of the transmission mechanism included in the electric tool as viewed from behind the transmission mechanism;

FIG. 7 is a graph illustrating how a regulating structure provided for the electric tool achieves the effect of stabilizing a torque value;

FIG. 8 is a graph illustrating how the regulating structure provided for the electric tool achieves the effect of stabilizing the torque value;

FIG. 9 is a cross-sectional view of a main part of the electric tool;

FIG. 10 is a graph illustrating how a second bearing provided for the electric tool achieves the effect of stabilizing a torque value; and

FIG. 11 is a graph illustrating how the second bearing provided for the electric tool achieves the effect of stabilizing the torque value.

### DESCRIPTION OF EMBODIMENTS

An electric tool 1 according to an exemplary embodiment of the present disclosure will now be described in detail with reference to the accompanying drawings. Note that the embodiment and its variations to be described below are only an exemplary one of various embodiments of the present disclosure and its variations and should not be construed as limiting. Rather, the exemplary embodiment and its variations may be readily modified in various manners depending on a design choice or any other factor without departing from a true spirit and scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio. The arrows indicating respective directions on the drawings are only examples and should not be construed as limiting the directions in which the electric tool 1 is used. Also, those arrows indicating the respective directions on the drawings are just shown there for illustrative purposes only and are all insubstantial ones.

### (1) Overview

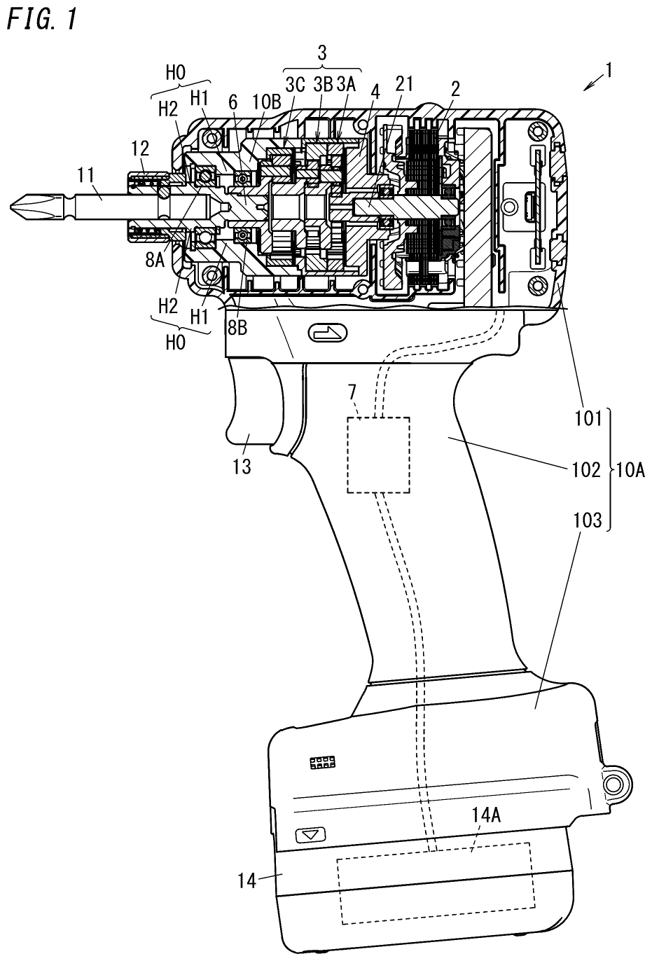

First, an overview of an electric tool 1 according to an exemplary embodiment will be described with reference to FIGS. 1, 2, and 9.

An electric tool 1 according to this embodiment includes a motor 2, an output shaft 6, a transmission mechanism 3, a first bearing 8A and a second bearing 8B, and a cover 10B as shown in FIG. 1.

The output shaft 6 is to be coupled to a tip tool 11 such as a screwdriver bit for use to fasten a fastening member such as a screw or a bolt.

The transmission mechanism 3 is engaged with the output shaft 6 and transmits torque generated by the motor 2 to the output shaft 6.

The first bearing 8A and the second bearing 8B support the output shaft 6 rotatably.

The cover 10B houses the motor 2, the transmission mechanism 3, the first bearing 8A, and the second bearing 8B.

The first bearing 8A is interposed between the second bearing 8B and the tip tool 11.

The second bearing 8B is arranged to be in contact with the transmission mechanism 3 and the cover 10B in a region where the transmission mechanism 3 is engaged with the output shaft 6.

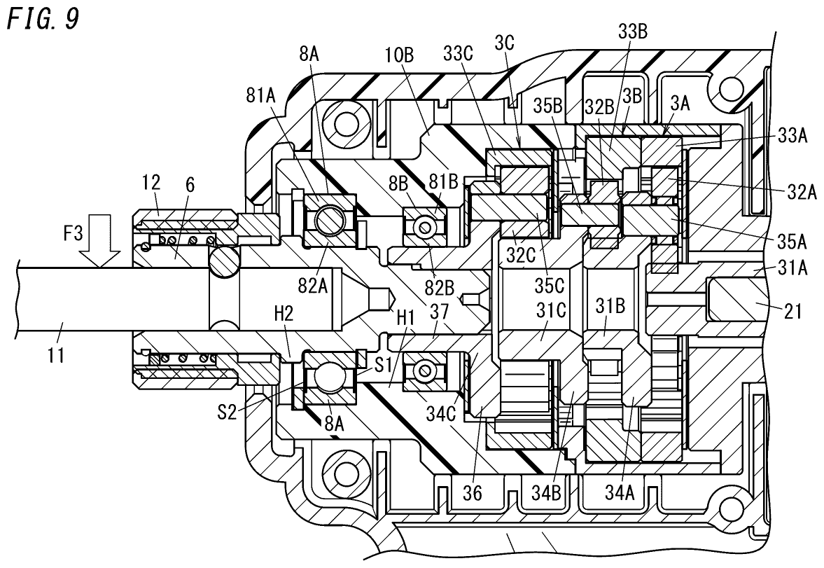

In the electric tool 1 according to this embodiment, the output shaft 6 is supported, via the transmission mechanism 3, by not only the second bearing 8B but also the cover 10B in contact with the second bearing 8B as shown in FIG. 9. This allows, when force (radial load) F3 is applied to the output shaft 6 in a direction intersecting with the axis of the output shaft 6, the cover 10B to receive the force F3, thus reducing the degree of eccentricity of the output shaft 6 and thereby contributing to stabilizing the operations being performed by the electric tool 1.

(2) Configuration for electric tool

Next, a configuration for the electric tool 1 according to this embodiment will be described in detail.

In the following description, the direction pointing from the motor 2 toward the output shaft 6 along the axis of the output shaft 6 is herein defined to be a “forward direction” and the direction pointing from the output shaft 6 toward the motor 2 along the axis of the output shaft 6 is herein defined to be a “backward direction” as shown in FIG. 1 and other drawings. Also, the direction pointing from a grip 102 toward a barrel 101 perpendicularly to the forward/backward directions is herein defined to be an “upward direction” and the direction pointing from the barrel 101 toward the grip 102 perpendicularly to the forward/backward directions is herein defined to be a “downward direction.”

The electric tool 1 is a portable electric tool (such as a screwdriver bit) which may be gripped by the worker with one of his or her hands. As shown in FIGS. 1, 2, and 4, the electric tool 1 includes the motor 2, the output shaft 6, the transmission mechanism 3, a bearing (first bearing) 8A, the cover 10B, a regulating structure HO, a housing 10A, an inertial body 4, a switch 13, a control unit 7, and a storage unit 9. In addition, the electric tool 1 further includes the second bearing 8B housed in the cover 10B to support the output shaft 6 rotatably.

The housing 10A includes the barrel 101, the grip 102, and an attachment 103. The barrel 101 is formed in the shape of a cylinder, of which the rear end is bottomed.

The barrel 101 houses the motor 2, the transmission mechanism 3, the first bearing 8A, and the second bearing 8B therein. More specifically, the barrel 101 houses the cover 10B, and the transmission mechanism 3, the first bearing 8A, and the second bearing 8B are housed in the cover 10B.

The grip 102 protrudes downward from the barrel 101. The grip 102 houses the control unit 7 therein.

The attachment 103 is provided at the tip (i.e., bottom) of the grip 102. In other words, the barrel 101 and the attachment 103 are coupled to each other via the grip 102. To the attachment 103, a battery pack 14 is attached removably.

A rechargeable battery pack 14 is attached removably to the electric tool 1. The electric tool 1 according to this embodiment is powered by the battery pack 14 as a power supply. That is to say, the battery pack 14 is a power supply 14A that supplies a current for driving the motor 2. In this embodiment, the battery pack 14 is not a constituent element of the electric tool 1. However, this is only an example and should not be construed as limiting. Alternatively, the electric tool 1 may include the battery pack 14 as one of its constituent elements. The battery pack 14 includes an assembled battery formed by connecting a plurality of secondary batteries (such as lithium-ion batteries) in series and a case that houses the assembled battery therein.

The motor 2 is a power source for the electric tool 1. The motor 2 may be a brushless motor, for example. In particular, the motor 2 according to this embodiment is a synchronous motor. More specifically, the motor 2 may be a permanent magnet synchronous motor (PMSM). The motor 2 includes: a rotor with a permanent magnet; and a stator with armature windings for three phases (namely, U-, V-, and W-phases). The rotor of the motor 2 has a drive shaft 21. The motor 2 transforms the electric power supplied from the battery pack 14 into the torque of the drive shaft 21.

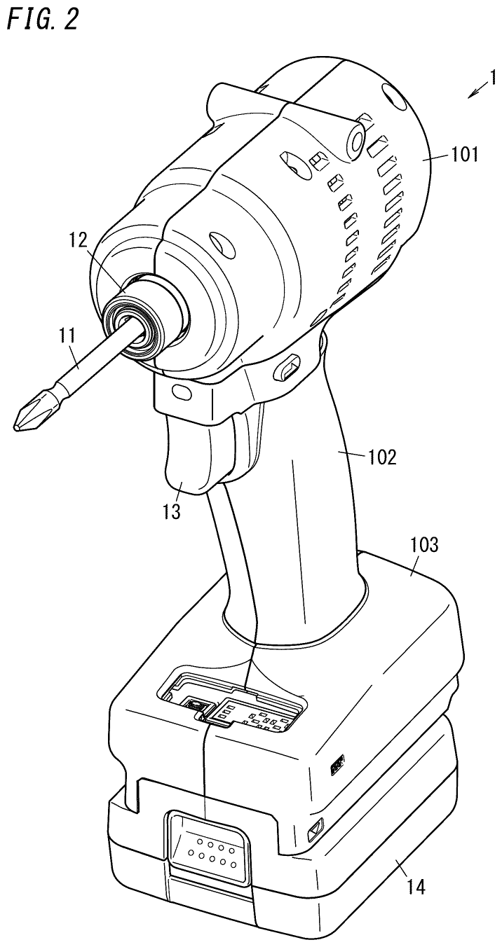

To the front end of the output shaft 6, coupled is a tip tool 11 such as a screwdriver bit via a chuck 12 as shown in FIGS. 1 and 2. That is to say, as the output shaft 6 rotates, the tip tool 11 turns. If the tip tool 11 that is a screwdriver bit is attached to the front end of the output shaft 6, turning the tip tool 11 which is set in place on a work target such as a screw allows the operations of either tightening or loosening the work target with respect to the workpiece to be performed.

In this embodiment, neither the chuck 12 not the tip tool 11 is a constituent element of the electric tool 1. However, this is only an example and should not be construed as limiting. Alternatively, the electric tool 1 may include at least one of the chuck 12 or the tip tool 11.

The transmission mechanism 3 is disposed forward of the motor 2. The drive shaft 21 of the motor 2 and the output shaft 6 are mechanically connected to the transmission mechanism 3. The transmission mechanism 3 transmits the torque of the motor 2 to the output shaft 6.

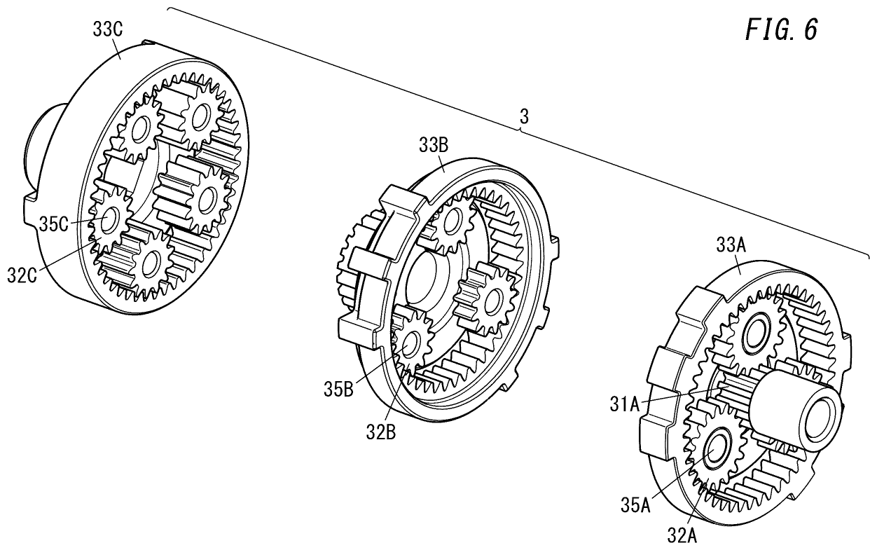

The transmission mechanism 3 according to this embodiment includes a first speed reducer mechanism 3A, a second speed reducer mechanism 3B, and a third speed reducer mechanism 3C as shown in FIGS. 1, 3, 5, and 6.

Each of the first speed reducer mechanism 3A, the second speed reducer mechanism 3B, and the third speed reducer mechanism 3C is a planetary gear mechanism for transforming the rotational velocity and torque of the drive shaft 21 of the motor 2 into a rotational velocity and torque required to have operations (such as the operation of turning a screw) done on the work target. The third speed reducer mechanism 3C, the second speed reducer mechanism 3B, and the first speed reducer mechanism 3A are arranged in this order from the front end toward the rear end of the electric tool 1.

The first speed reducer mechanism 3A includes a first sun gear 31A, a plurality of (e.g., three) first planetary gears 32A, a first internal gear 33A, and a first carrier 34A as shown in FIGS. 1, 3, 5, and 6. The first sun gear 31A is coupled to the drive shaft 21 of the motor 2 as shown in FIG. 1. The three first planetary gears 32A are arranged around the first sun gear 31A to mesh with the first sun gear 31A. The first internal gear 33A is arranged around the three first planetary gears 32A to mesh with the three first planetary gears 32A. The first carrier 34A supports the respective rotary shafts 35A of the three first planetary gears 32A. Specifically, the first carrier 34A supports the three first planetary gears 32A to make each of the three first planetary gears 32A rotatable with respect to the first carrier 34A. Specifically, the first carrier 34A supports each rotary shaft 35A rotatably with respect to the first carrier 34A itself. In this case, each rotary shaft 35A is fixed to a corresponding one of the first planetary gears 32A. Alternatively, the rotary shafts 35A may be fixed to the first carrier 34A. In that case, the rotary shafts 35A will be supported rotatably with respect to the first planetary gears 32A. In this manner, the first speed reducer mechanism 3A transforms the rotation of the drive shaft 21 into the rotation of the first carrier 34A.

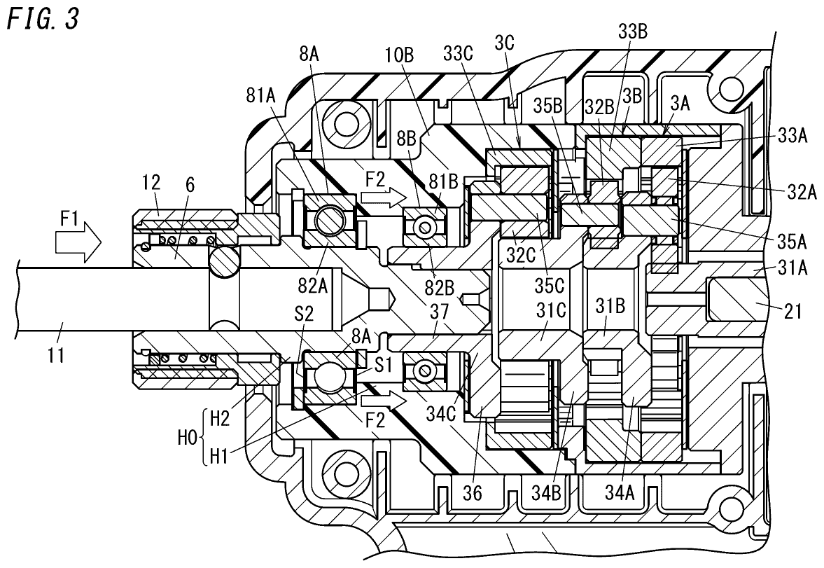

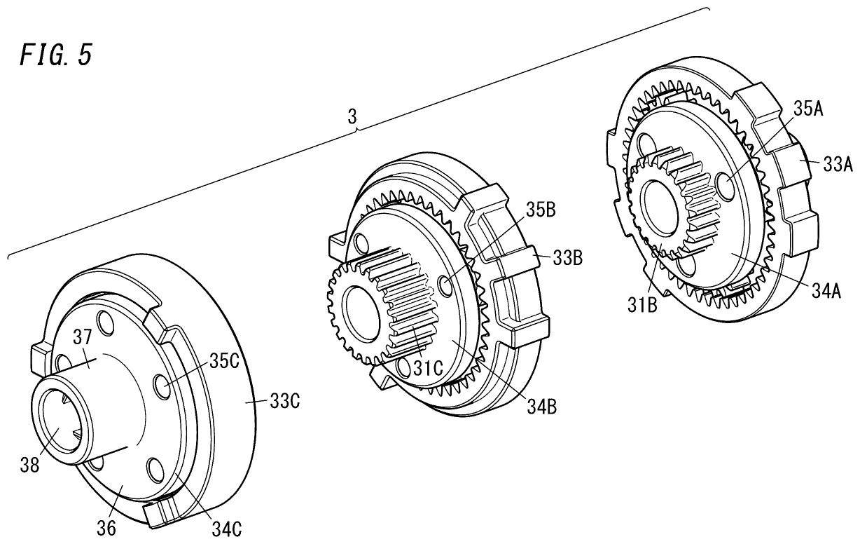

The second speed reducer mechanism 3B includes a second sun gear 31B, a plurality of (e.g., three) second planetary gears 32B, a second internal gear 33B, and a second carrier 34B as shown in FIGS. 1, 3, 5, and 6. The second sun gear 31B is formed integrally with the first carrier 34A as shown in FIGS. 3 and 5. That is to say, the first carrier 34A and the second sun gear 31B turn integrally with each other. The three second planetary gears 32B are arranged around the second sun gear 31B to mesh with the second sun gear 31B. The second internal gear 33B is arranged around the three second planetary gears 32B to mesh with the three second planetary gears 32B. The second carrier 34B supports the respective rotary shafts 35B of the three second planetary gears 32B. Specifically, the second carrier 34B supports the three second planetary gears 32B to make each of the three second planetary gears 32B rotatable with respect to the second carrier 34B itself. That is to say, the second speed reducer mechanism 3B transforms the rotation of the first carrier 34A into the rotation of the second carrier 34B.

The third speed reducer mechanism 3C includes a third sun gear 31C, a plurality of (e.g., five) third planetary gears 32C, a third internal gear 33C, and a third carrier 34C as shown in FIGS. 1, 3, 5, and 6. The third sun gear 31C is formed integrally with the second carrier 34B as shown in FIGS. 3 and 5. The second carrier 34B and the third sun gear 31C turn integrally with each other. That is to say, the third sun gear 31C is caused to turn with the motive power supplied from the motor 2 via the first speed reducer mechanism 3A and the second speed reducer mechanism 3B. The five third planetary gears 32C are arranged around the third sun gear 31C to mesh with the third sun gear 31C. The third internal gear 33C is arranged around the five third planetary gears 32C to mesh with the five third planetary gears 32C. The third carrier 34C supports the respective rotary shafts 35C of the five third planetary gears 32C. Specifically, the third carrier 34C supports the five third planetary gears 32C to make each of the five third planetary gears 32C rotatable with respect to the third carrier 34C itself. More specifically, the third carrier 34C includes an annular disk portion 36 and a hollow cylindrical portion 37 protruding forward from the disk portion 36. The disk portion 36 supports the respective rotary shafts 35C of the five third planetary gears 32C rotatably. Also, the output shaft 6 and an engagement hole 38 (refer to FIG. 5 and other drawings) provided as a center hole for the cylindrical portion 37 are combined with each other to regulate the rotation of the cylindrical portion 37 with respect to the output shaft 6 in a circumferential direction by having a projection provided for one selected from the output shaft 6 and the engagement hole 38 engaged with a recess provided for the other in the circumferential direction. In addition, the engagement hole 38 and the output shaft 6 are fitted into each other by gap fitting. That is to say, the output shaft 6 and the transmission mechanism 3 are engaged with each other by gap fitting. In other words, the output shaft 6 is engaged with the third carrier 34C to prevent the force to be transmitted to the output shaft 6 in the axial direction from being transmitted to the third carrier 34C. Furthermore, the output shaft 6 is engaged with the third carrier 34C with its rotation with respect to the third carrier 34C regulated. Thus, the output shaft 6 rotates integrally with the third carrier 34C. That is to say, the third speed reducer mechanism 3C transforms the rotation of the second carrier 34B into the rotation of the output shaft 6.

The first bearing 8A is housed in a tip portion of the cover 10B and supports the output shaft 6 rotatably. The first bearing 8A may be, for example, a hollow circular columnar ball bearing. The first bearing 8A includes an outer ring 81A, an inner ring 82A, and spherical rolling elements as shown in FIG. 3. The first bearing 8A makes the inner ring 82A support the output shaft 6 rotatably with the outer ring 81A held by the cover 10B. In addition, the first bearing 8A also has a first end surface S1 and a second end surface S2 which face each other along the axis of the output shaft 6 (i.e., in the forward/backward direction). The first end surface S1 is an end surface facing the motor 2. The second end surface S2 is an end surface facing the tip tool 11. The first bearing 8A is provided with the first end surface S1 kept out of contact with the third carrier 34C in the forward/backward direction.

In this embodiment, the cover 10B includes a first holding portion H1 arranged in contact with at least a part of the first end surface S1. The first holding portion H1 may be, for example, a ringlike portion protruding inward from an inner wall of the cover 10B. The first end surface S1 and the first holding portion H1 are in contact with each other in the forward/backward direction. Note that the first holding portion H1 does not have to be a ringlike portion but may also be a portion in the shape of a projection, for example.

Meanwhile, the output shaft 6 includes a second holding portion H2 arranged in contact with at least a part of the second end surface S2. The second holding portion H2 may be, for example, a ringlike portion protruding outward from the surface of the output shaft 6. The second end surface S2 and the second holding portion H2 are in contact with each other in the forward/backward direction. Note that the second holding portion H2 does not have to be a ringlike portion but may also be a portion in the shape of a projection, for example.

As can be seen, the first bearing 8A is sandwiched between the first holding portion H1 and the second holding portion H2 in the forward/backward direction to have its movement regulated in the forward/backward direction. That is to say, the first holding portion H1 and the second holding portion H2 form a regulating structure H0 for regulating the movement of the first bearing 8A along the axis of the output shaft 6 (i.e., in the forward/backward direction).

The second bearing 8B is housed inside the cover 10B backward of the first bearing 8A and the first holding portion H1 and supports the output shaft 6 rotatably. In this embodiment, the tip tool 11 is attached to the output shaft 6 via the chuck 12 forward of the first bearing 8A. Thus, the first bearing 8A is interposed between the second bearing 8B and the tip tool 11.

The second bearing 8B may be, for example, a hollow circular columnar ball bearing. The second bearing 8B includes an outer ring 81B, an inner ring 82B, and spherical rolling elements as shown in FIG. 3. The second bearing 8B makes the inner ring 82B support the cylindrical portion 37 of the third carrier 34C with the outer ring 81B held by the cover 10B. In this case, the cylindrical portion 37 is engaged with the output shaft 6. Thus, the second bearing 8B is arranged to be in contact with the third carrier 34C and the cover 10B in a part where the third carrier 34C is engaged with the output shaft 6. That is to say, the second bearing 8B is arranged to be in contact with the transmission mechanism 3 and the cover 10B in the part where the transmission mechanism 3 is engaged with the output shaft 6.

The inertial body 4 is interposed between the first speed reducer mechanism 3A and the motor 2 as shown in FIG. 1. Specifically, the inertial body 4 is disposed forward of the motor 2 and backward of the first speed reducer mechanism 3A. The inertial body 4 is mechanically connected to the drive shaft 21 and rotates integrally with the drive shaft 21. The inertial body 4 is a so-called “flywheel” and increases the inertial force of the torque of the (drive shaft 21 of the) motor 2 The switch 13 protrudes forward from the grip 102 as shown in FIG. 1. The switch 13 is an operating member that accepts an operating command entered by the user to control the motor 2. Specifically, the worker may turn ON and OFF the motor 2 by pulling the switch 13. In addition, the rotational velocity of the drive shaft 21 may also be adjusted depending on how deep the switch 13 is pulled. For example, the deeper the switch 13 is pulled, the higher the rotational velocity of the drive shaft 21 becomes.

The storage unit 9 may be implemented as, for example, a read-only memory (ROM), a random-access memory (RAM), or an electrically erasable programmable read-only memory (EEPROM). The storage unit 9 stores a control program to be executed by the control unit 7. In addition, the storage unit 9 also stores a preset value of the fastening torque (i.e., preset torque value).

The control unit 7 includes a computer system including one or more processors and a memory. At least some of the functions of the control unit 7 are performed by making the processor of the computer system execute a program stored in the memory of the computer system. The program may be stored in the memory. Alternatively, the program may also be downloaded via a telecommunications line such as the Internet or distributed after having been stored in a non-transitory storage medium such as a memory card.

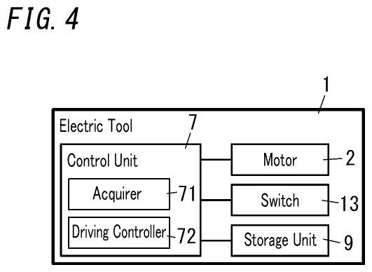

The control unit 7 includes an acquirer 71 and a driving controller 72 as shown in FIG. 4. Note that the acquirer 71 and the driving controller 72 do not necessarily have a substantive configuration but only represent functions to be performed by the control unit 7.

The acquirer 71 acquires, based on the amount of current flowing through the motor 2, a torque value associated with the output torque provided by the tip tool 11.

The driving controller 72 controls the motor 2. The driving controller 72 may control the motor 2 by vector control, for example. The driving controller 72 breaks down a motor current, which is a current to be supplied to the motor 2, into a torque current (q-axis current) that generates torque and an excitation current (d-axis current) that generates a magnetic flux and controls these current components independently of each other. Note that the method by which the driving controller 72 controls the motor 2 does not have to be the vector control but may also be a control method different from the vector control.

The driving controller 72 controls the motor 2 to make the torque value measured by the acquirer 71 equal to the preset torque value stored in advance in the storage unit 9. For example, when the difference between the torque value detected by the acquirer 71 and the preset torque value falls within a predetermined tolerance range (e.g., ±20% of the preset torque value), the driving controller 72 controls the motor 2 to stop rotating the drive shaft 21.

### (3) Advantages

The electric tool 1 according to this embodiment is used to perform operations with a tip tool pressed against a work target (such as a screw). Thus, a thrust load F1 is applied as reaction force from the work target to the tip tool 11 and the output shaft 6, which is coupled to the tip tool 11, in the direction aligned with the axis of the output shaft 6 (i.e., in the forward/backward direction) as shown in FIG. 3. As described above, the electric tool 1 has the regulating structure H0 (including the first holding portion H1 and the second holding portion H2) that sandwiches the first bearing 8A in the forward/backward direction. Thus, the thrust load F1 applied in the axial direction to the output shaft 6 is transmitted from the second holding portion H2 provided for the output shaft 6 to the second end surface S2 of the first bearing 8A. Then, the thrust load F1 transmitted to the second end surface S2 is transmitted as force F2 from the first end surface S1 to the first holding portion H1 provided for the cover 10B. That is to say, the thrust load F1 applied to the output shaft 6 is broken down into the force F2. This may reduce the degree of eccentricity of the output shaft 6, thus contributing to stabilizing the operations being performed by the electric tool 1.

In addition, the transmission mechanism 3 is housed inside the cover 10B to prevent the force applied in the forward/backward direction from being transmitted from the cover 10B. Thus, the thrust load F1 transmitted to the first holding portion H1 is not transmitted to the third carrier 34C of the transmission mechanism 3. Furthermore, the output shaft 6 and the engagement hole 38 of the third carrier 34C are engaged with each other by gap fitting, and therefore, the thrust load F1 applied to the output shaft 6 is not transmitted to the cylindrical portion 37 of the third carrier 34C. Besides, the first bearing 8A and the third carrier 34C are spaced from each other in the forward/backward direction. Thus, even if the first holding portion H1 is deformed under the thrust load F1 transmitted from the first end surface S1, for example, the first bearing 8A does not come into contact with the third carrier 34C. Consequently, the thrust load F1 transmitted to the first bearing 8A is not transmitted from the first bearing 8A to the third carrier 34C.

This may reduce, even if the thrust load F1 is applied to the transmission mechanism 3 in the forward/backward direction, the chances of producing frictional force between the plurality of gears included in the transmission mechanism 3, thus enabling stabilizing the torque value acquired by the acquirer 71. Specifically, the torque value may be stabilized by preventing the acquirer 71 from detecting a variation in the amount of current flowing through the motor 2 due to the frictional force produced in the transmission mechanism 3.

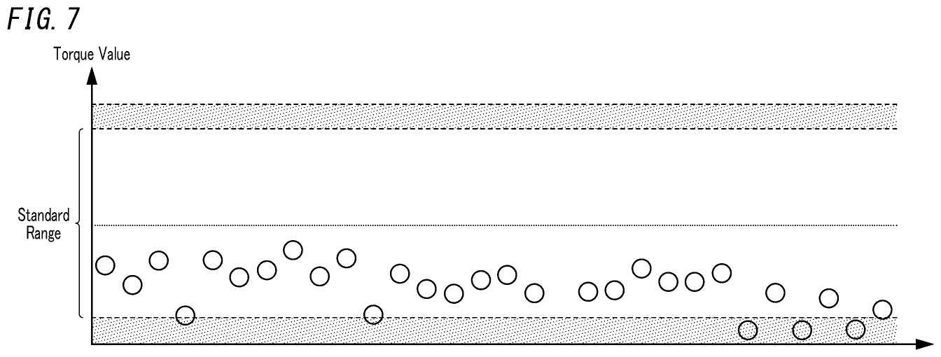

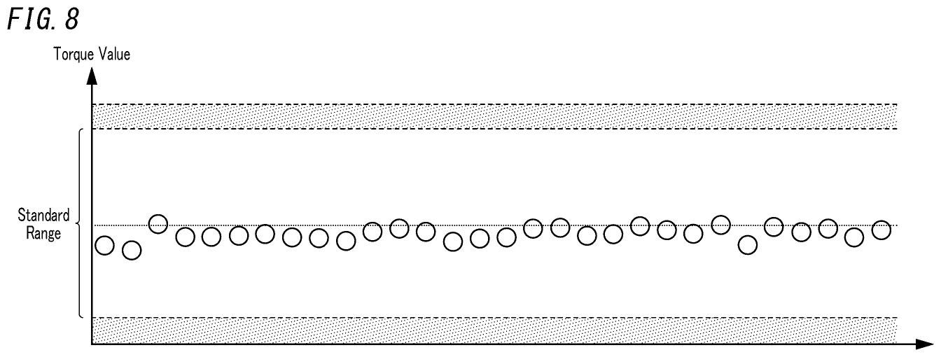

Next, it will be described with reference to FIGS. 7 and 8 how the regulating structure HO achieves the advantage of stabilizing the torque value. In FIG. 7, the ordinate indicates a torque value in a situation where the thrust load F1 is applied to the output shaft in an electric tool according to a comparative example without regulating structure H0. On the other hand, in FIG. 8, the ordinate indicates a torque value in a situation where the thrust load F1 is applied to the output shaft in the electric tool 1 according to this embodiment with the regulating structure H0. As shown in FIGS. 7 and 8, the torque value is less dispersed in the electric tool 1 according to this embodiment than in the electric tool according to the comparative example. Thus, every torque value shown in FIG. 8 falls within a standard range.

Also, while the electric tool 1 according to this embodiment is being used to perform operations on a work target (such as a screw), force (a radial load) F3 (refer to FIG. 9) may be applied in a direction intersecting with the axis of the output shaft 6 to the tip tool 11 and the output shaft 6 due to, for example, the movement of the worker who is holding the electric tool 1. As described above, the electric tool 1 includes the second bearing 8B arranged to be in contact with the transmission mechanism 3 and the cover 10B in a region where the transmission mechanism 3 is engaged with the output shaft 6. More specifically, the second bearing 8B is arranged such that at least a part of the output shaft 6, at least a part of the third carrier 34C, and at least a part of the second bearing 8B overlap with each other when viewed in a direction intersecting with the axis of the output shaft 6. That is to say, the output shaft 6 is supported by the second bearing 8B via the third carrier 34C and is further supported by the cover 10B in contact with the second bearing 8B.

This allows, even when the radial load F3 is applied to the output shaft 6, the cover 10B to receive the radial load F3 applied to the output shaft 6, thus reducing the external force applied to the transmission mechanism 3 under the radial load F3. This may reduce the chances of producing frictional force between the plurality of gears included in the transmission mechanism 3, thus stabilizing the torque value acquired by the acquirer 71.

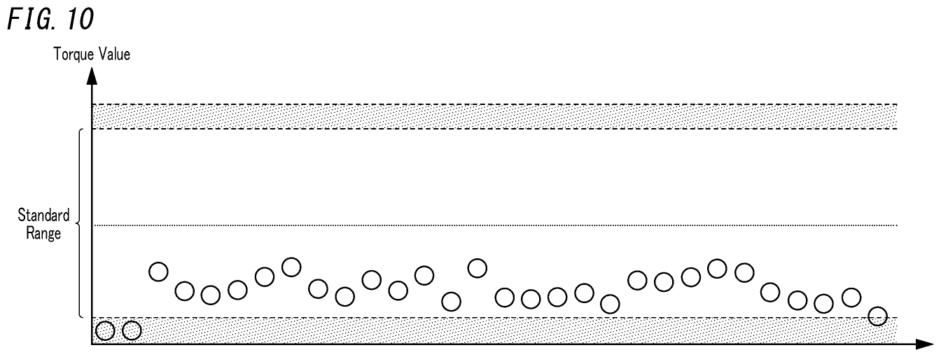

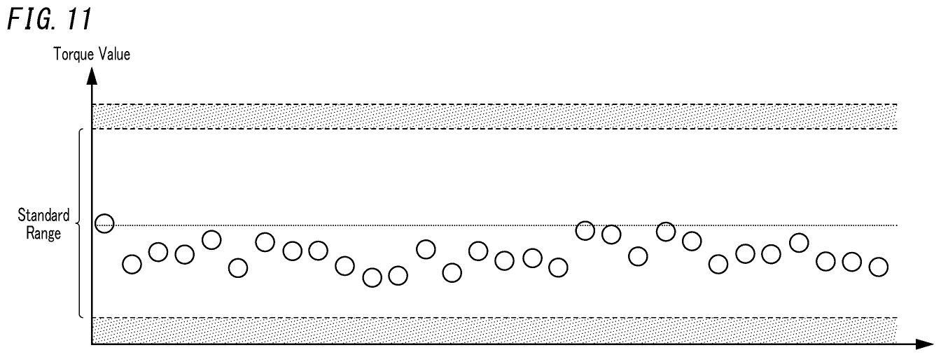

Next, it will be described with reference to FIGS. 10 and 11 how the second bearing 8B achieves the advantage of stabilizing the torque value. In FIG. 10, the ordinate indicates a torque value in a situation where the radial load F3 is applied to the output shaft in an electric tool according to a second comparative example without the second bearing 8B. On the other hand, in FIG. 11, the ordinate indicates a torque value in a situation where the radial load F3 is applied to the output shaft in the electric tool 1 according to this embodiment with the second bearing 8B. As shown in FIGS. 10 and 11, the torque value is less dispersed in the electric tool 1 according to this embodiment than in the electric tool according to the second comparative example. Thus, every torque value shown in FIG. 11 falls within a standard range.

As can be seen from the foregoing description, the electric tool 1 according to this embodiment contributes to stabilizing the operations being performed.

### (4) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure.

Next, variations of the exemplary embodiment will be enumerated one after another. Note that the variations to be described below may be adopted in combination as appropriate.

The electric tool 1 according to the present includes a computer system in its control unit 7. The computer system includes a processor and a memory as principal hardware components thereof. The computer system performs the functions of the control unit 7 according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

To the electric tool 1, a socket may also be attached as a tip tool 11 instead of the screwdriver bit. In addition, the electric tool 1 does not have to be configured to use the battery pack 14 as a power supply but may also be configured to use an AC power supply (commercial power supply) as its power supply.

### (5) Recapitulation

As can be seen from the foregoing description, an electric tool (1) according to a first aspect includes a motor (2), an output shaft (6), a transmission mechanism (3), a first bearing (8A) and a second bearing (8B), and a cover (10B). The output shaft (6) is to be coupled to a tip tool (11). The transmission mechanism (3) is engaged with the output shaft (6) to transmit torque generated by the motor (2) to the output shaft (6). The first bearing (8A) and the second bearing (8B) are arranged to support the output shaft (6) rotatably. The cover (10B) houses the motor (2), the transmission mechanism (3), the first bearing (8A), and the second bearing (8B). The first bearing (8A) is interposed between the second bearing (8B) and the tip tool (11). The second bearing (8B) is arranged to be in contact with the transmission mechanism (3) and the cover (10B) in a region where the transmission mechanism (3) is engaged with the output shaft (6).

According to this aspect, the output shaft (6) is supported, via the transmission mechanism (3), by not only the second bearing (8B) but also the cover (10B) in contact with the second bearing (8B). This may reduce, when force (F3) is applied to the output shaft (6) in a direction intersecting with the axis of the output shaft (6), the degree of eccentricity of the output shaft (6), thus contributing to stabilizing the operations being performed by the electric tool (1).

An electric tool (1) according to a second aspect, which may be implemented in conjunction with the first aspect, further includes an acquirer (71) which acquires, based on a current flowing through the motor (2), a torque value associated with output torque provided by the tip tool (11).

This aspect allows operations to be performed with appropriate torque on a work target by comparing a torque value acquired by the acquirer (71) with a preset torque value.

In an electric tool (1) according to a third aspect, which may be implemented in conjunction with the first or second aspect, the transmission mechanism (3) includes a sun gear (31C), a plurality of planetary gears (32C), an internal gear (33C), and a carrier (34C). The sun gear (31C) turns with motive power supplied from the motor (2). The plurality of planetary gears (32C) are arranged around the sun gear (31C) to mesh with the sun gear (31C). The internal gear (33C) is arranged around the plurality of planetary gears (32C) to mesh with the plurality of planetary gears (32C). The carrier (34C) is engaged with the output shaft (6) to support each of the plurality of planetary gears (32C) rotatably. The second bearing (8B) is arranged to be in contact with the carrier (34C) and the cover (10B) in a region where the carrier (34C) is engaged with the output shaft (6).

According to this aspect, the output shaft (6) is supported, via the carrier (34C), by not only the second bearing (8B) but also the cover (10B) in contact with the second bearing (8B). This may reduce, when force (F3) is applied to the output shaft (6) in a direction intersecting with the axis of the output shaft (6), the degree of eccentricity of the output shaft (6), thus contributing to stabilizing the operations being performed by the electric tool (1).

In an electric tool (1) according to a fourth aspect, which may be implemented in conjunction with the third aspect, at least a part of the output shaft (6), at least a part of the carrier (34C), and at least a part of the second bearing (8B) are arranged to overlap with each other when viewed in a direction intersecting with an axis of the output shaft (6).

According to this aspect, the output shaft (6) is supported, via the carrier (34C), by not only the second bearing (8B) but also the cover (10B) in contact with the second bearing (8B). This may reduce, when force (F3) is applied to the output shaft (6) in a direction intersecting with the axis of the output shaft (6), the degree of eccentricity of the output shaft (6), thus contributing to stabilizing the operations being performed by the electric tool (1).

Note that the constituent elements according to the second to fourth aspects are not essential constituent elements for the electric tool (1) but may be omitted as appropriate.

### REFERENCE SIGNS LIST

1 Electric Tool
2 Motor
6 Output Shaft
3 Transmission Mechanism
31C Sun Gear
32C Planetary Gear
33C Internal Gear
34C Carrier
8A Bearing
10B Cover
11 Tip Tool
71 Acquirer
8B Second Bearing
F3 Force

1. An electric tool comprising:
a motor;
an output shaft configured to be coupled to a tip tool;
a transmission mechanism engaged with the output shaft to transmit torque generated by the motor to the output shaft;
a first bearing and a second bearing both arranged to support the output shaft rotatably; and
a cover arranged to house the motor, the transmission mechanism, the first bearing, and the second bearing,
the first bearing being interposed between the second bearing and the tip tool, and
the second bearing being arranged to be in contact with the transmission mechanism and the cover in a region where the transmission mechanism is engaged with the output shaft.

2. The electric tool of claim 1, further comprising an acquirer configured to acquire, based on a current flowing through the motor, a torque value associated with output torque provided by the tip tool.

3. The electric tool of claim 1, wherein
the transmission mechanism includes:
a sun gear configured to turn with motive power supplied from the motor;
a plurality of planetary gears arranged around the sun gear to mesh with the sun gear;
an internal gear arranged around the plurality of planetary gears to mesh with the plurality of planetary gears; and
a carrier engaged with the output shaft to support each of the plurality of planetary gears rotatably, wherein
the second bearing is arranged to be in contact with the carrier and the cover in a region where the carrier is engaged with the output shaft.

4. The electric tool of claim 3, wherein
at least a part of the output shaft, at least a part of the carrier, and at least a part of the second bearing are arranged to overlap with each other when viewed in a direction intersecting with an axis of the output shaft.

5. The electric tool of claim 2, wherein
the transmission mechanism includes:
a sun gear configured to turn with motive power supplied from the motor;
a plurality of planetary gears arranged around the sun gear to mesh with the sun gear;
an internal gear arranged around the plurality of planetary gears to mesh with the plurality of planetary gears; and
a carrier engaged with the output shaft to support each of the plurality of planetary gears rotatably, wherein
the second bearing is arranged to be in contact with the carrier and the cover in a region where the carrier is engaged with the output shaft.

6. The electric tool of claim 5, wherein
at least a part of the output shaft, at least a part of the carrier, and at least a part of the second bearing are arranged to overlap with each other when viewed in a direction intersecting with an axis of the output shaft.
